(19) United States
(12) Patent Application Publication
(10) Pub. No.: US 2026/0060332 A1
(43) Pub. Date: Mar. 5, 2026

(54) HEATING STRUCTURE, HEAT-NOT-BURN DEVICE, AND HEATING CONTROL METHOD THEREFOR

(71) Applicant: SMOORE INTERNATIONAL HOLDINGS LIMITED, George Town (KY)

(72) Inventors: Lei MA, Shenzhen (CN); Pengchong ZHANG, Shenzhen (CN); Xianwu DU, Shenzhen (CN); Xingfu ZHANG, Shenzhen (CN); Hengheng DOU, Shenzhen (CN); Xiangzhong LI, Shenzhen (CN); Rihong LI, Shenzhen (CN); Hongming ZHOU, Shenzhen (CN); Shiyuan LIU, Shenzhen (CN)

(21) Appl. No.: 19/383,451

(22) Filed: Nov. 7, 2025

Related U.S. Application Data
(63) Continuation of application No. PCT/CN2024/091479, filed on May 7, 2024.

(30) Foreign Application Priority Data
May 9, 2023 (CN) 202310519788.6

(51) Int. Cl. A24F 40/57; A24F 40/20; A24F 40/46; A24F 40/51; A24F 40/53

(52) U.S. Cl. CPC A24F 40/57; A24F 40/46; A24F 40/51; A24F 40/53; A24F 40/20

(57) ABSTRACT

A heating control method for a heat-not-burn device that includes a heating element and a temperature measurement module includes: performing heating control on the heating element in a power control mode in a preheat stage so as to preheat an aerosol-forming substrate; and obtaining, in a heating stage subsequent to the preheating stage, a temperature detected by the temperature measurement module, and performing heating control on the heating element in a temperature control mode so as to cause a temperature of the heating element to maintain at a preset heat preserving temperature.

### CROSS-REFERENCE TO PRIOR APPLICATION

This application is a continuation of International Patent Application No. PCT/CN2024/091479, filed on May 7, 2024, which claims priority to Chinese Patent Application No. 202310519788.6, filed on May 9, 2023. The entire disclosure of both applications is hereby incorporated by reference herein.

### FIELD

The present invention relates to the atomization field of heat-not-burn, and in particular, to a heating structure, a heat-not-burn device, and a heating control method therefor.

### BACKGROUND

Heat-not-burn devices include many types of heating elements. For a heating element of a temperature coefficient of resistance (TCR), the temperature of the heating element cannot be accurately measured based on a resistance of the heating element. Therefore, an additional temperature measurement device needs to be added to measure the temperature inside an aerosol-forming substrate. However, the temperature measurement device lags behind in temperature measurement. In particular, in a preheating stage, the temperature detected by the temperature measurement device cannot truly reflect the temperature inside the aerosol-forming substrate, so that the heating temperature in the preheating stage cannot be effectively controlled.

### SUMMARY

In an embodiment, the present invention provides a heating control method for a heat-not-burn device that includes a heating element and a temperature measurement module, the heating control method comprising: performing heating control on the heating element in a power control mode in a preheat stage so as to preheat an aerosol-forming substrate; and obtaining, in a heating stage subsequent to the preheating stage, a temperature detected by the temperature measurement module, and performing heating control on the heating element in a temperature control mode so as to cause a temperature of the heating element to maintain at a preset heat preserving temperature.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a flowchart of a heating control method for a heat-not-burn device according to Embodiment 1 of the present invention;

FIG. 2 is a graph of a temperature control curve of heating an aerosol-forming substrate according to the present invention;

FIG. 3 is a graph of a curve of heating control on a heating element according to the present invention;

FIG. 4 is a structural diagram of a heat-not-burn device according to a first embodiment of the present invention;

FIG. 5 is a schematic structural diagram of a heating structure in the heat-not-burn device shown in FIG. 4;

FIG. 6 is a sectional view of the heating structure shown in FIG. 5;

FIG. 7 is a schematic structural exploded view of the heating structure shown in FIG. 5;

FIG. 8 is a schematic structural diagram of a heating structure in a heat-not-burn device according to a second embodiment of the present invention;

FIG. 9 is a schematic structural diagram of the heating structure shown in FIG. 8 in another angle;

FIG. 10 is a sectional view of the heating structure shown in FIG. 8;

FIG. 11 is a schematic structural exploded view of the heating structure shown in FIG. 8; and

FIG. 12 is a cross-sectional view of a heating element.

### DETAILED DESCRIPTION

In an embodiment, the present invention provides a heating control method of a heat-not-burn device, where the heat-not-burn device includes a heating element and a temperature measurement module, and a heating process includes a preheating stage and a heating stage subsequent to the preheating stage. The heating control method includes:
performing heating control on the heating element in a power control mode in the preheat stage, to preheat an aerosol-forming substrate; and
obtaining, in the heating stage, a temperature detected by the temperature measurement module, and performing heating control on the heating element in a temperature control mode, to cause the temperature of the heating element to maintain at a heat preservation temperature.

Preferably, the step of preheating an aerosol-forming substrate includes:
preheating the aerosol-forming substrate through infrared radiation; and
the step of maintaining the temperature of the heating element at a preset heat preservation temperature includes:
maintaining the temperature of the heating element at the preset heat preservation temperature, and heating the aerosol-forming substrate through infrared radiation.

Preferably, the method further includes:
if the first smoking action is detected in the preheating stage, or a current preheat time reaches a first preset time, entering the heating stage.

Preferably, the method further includes:
outputting a reminder signal if no first smoking action is detected in the preheating stage within a second preset time, where the second preset time is less than or equal to the first preset time.

Preferably, a preheat temperature in the preheating stage is 300° C. to 400° C.; and/or the heat preservation temperature in the heating stage is 180° C. to 380° C.; and/or
the first preset time is 1 s to 10 s.

Preferably, the step of performing heating control on the heating element in a power control mode includes:
obtaining, when heating is started, an initial temperature detected by the temperature measurement module; and
determining an initial heating power of the heating element based on the initial temperature.

Preferably, the step of performing heating control on the heating element in a power control mode includes:
performing heating control on the heating element in a constant power control mode; or
performing heating control on the heating element in a variable power control mode.

Preferably, the method further includes:
collecting statistics on a current total number of times of smoking and/or a current accumulated heating time in the heating stage, and adjusting the heat preservation temperature according to the current total number of times of smoking and/or the current accumulated heating time.

Preferably, the step of obtaining a temperature detected by the temperature measurement module, and performing heating control on the heating element in a temperature control mode includes:
obtaining, in real time, a temperature detected by the temperature measurement module, and using the temperature as a detected temperature value;
using the heat preservation temperature as a target temperature value; and
performing PID calculation on the detected temperature value and the target temperature value, and performing heating control on the heating element according to a PID calculation result.

Preferably, the method further includes:
stopping heating control on the heating element when determining that a preset stop condition is met, where the preset stop condition includes at least one of the following:
a total number of times of smoking reaches a preset number of times;
an accumulated heating time reaches a third preset time; and
a stop instruction inputted by a user is received.

The present invention further constructs a computer storage medium, storing a computer program, where the computer program, when executed by a processor, implements the steps of the heating control method of a heat-not-burn device described above.

The present invention further constructs a heat-not-burn device, including a processor and a memory storing a computer program, where when executing the computer program, the processor implements the steps of the heating control method of a heat-not-burn device described above.

The present invention further constructs a heating structure, including a heating element and a tube element, where the heating element is powered on for heating according to the foregoing heating control method and is configured to radiate infrared light, the heating element is at least partially spaced from the tube wall of the tube element, the tube wall of the tube element allows the infrared light to penetrate through, and the infrared light is configured to heat an aerosol-forming substrate.

Preferably, the heating element includes a heating substrate and an infrared radiation layer disposed on the outer surface of the heating substrate, where
the heating substrate is powered on for heating and is configured to excite the infrared radiation layer to radiate infrared light.

Preferably, the tube element is configured to be at least partially inserted into an aerosol-forming substrate and includes a body portion and a tip portion disposed at one end of the body portion, and the heating element is spaced from the inner wall of the body portion.

Preferably, the heating element is disposed in the periphery of the tube element, an accommodating cavity is disposed in the tube element, and the aerosol-forming substrate is at least partially accommodated in the accommodating cavity.

### Technical Problem

A technical problem to be resolved by the present invention is a technical defect in the prior art that a heating temperature in a preheating stage cannot be effectively controlled.

### Beneficial Effect

To resolve the foregoing technical defect in the prior art, a technical problem to be resolved by the present invention is to provide a heating structure, a heat-not-burn device, and a heating control method therefor.

A technical solution used in the present invention to resolve the technical problem thereof is: constructing a heating control method of a heat-not-burn device, where the heat-not-burn device includes a heating element and a temperature measurement module, and a heating process includes a preheating stage and a heating stage subsequent to the preheating stage. The heating control method includes:
performing heating control on the heating element in a power control mode in the preheating stage, to preheat an aerosol-forming substrate; and
obtaining, in the heating stage, a temperature detected by the temperature measurement module, and performing heating control on the heating element in a temperature control mode, to cause the temperature of the heating element to maintain at a heat preservation temperature.

Preferably, the step of preheating an aerosol-forming substrate includes:
preheating the aerosol-forming substrate through infrared radiation; and
the step of maintaining the temperature of the heating element at a preset heat preservation temperature includes:
maintaining the temperature of the heating element at the preset heat preservation temperature, and heating the aerosol-forming substrate through infrared radiation.

Preferably, the method further includes:
if the first smoking action is detected in the preheating stage, or a current preheat time reaches a first preset time, entering the heating stage.

Preferably, the method further includes:
outputting a reminder signal if no first smoking action is detected in the preheating stage within a second preset time, where the second preset time is less than or equal to the first preset time.

Preferably, a preheat temperature in the preheating stage is 300° C. to 400° C.; and/or
the heat preservation temperature in the heating stage is 180° C. to 380° C.; and/or
the first preset time is 1 s to 10 s.

Preferably, the step of performing heating control on the heating element in a power control mode includes:
obtaining, when heating is started, an initial temperature detected by the temperature measurement module; and
determining an initial heating power of the heating element based on the initial temperature.

Preferably, the step of performing heating control on the heating element in a power control mode includes:
performing heating control on the heating element in a constant power control mode; or
performing heating control on the heating element in a variable power control mode.

Preferably, the method further includes:
collecting statistics on a current total number of times of smoking and/or a current accumulated heating time in the heating stage, and adjusting the heat preservation temperature according to the current total number of times of smoking and/or the current accumulated heating time.

Preferably, the step of obtaining a temperature detected by the temperature measurement module, and performing heating control on the heating element in a temperature control mode includes:
obtaining, in real time, a temperature detected by the temperature measurement module, and using the temperature as a detected temperature value;
using the heat preservation temperature as a target temperature value; and
performing PID calculation on the detected temperature value and the target temperature value, and performing heating control on the heating element according to a PID calculation result.

Preferably, the method further includes:
stopping heating control on the heating element when determining that a preset stop condition is met, where the preset stop condition includes at least one of the following:
a total number of times of smoking reaches a preset number of times;
an accumulated heating time reaches a third preset time; and
a stop instruction inputted by a user is received.

The present invention further constructs a computer storage medium, storing a computer program, where the computer program, when executed by a processor, implements the steps of the heating control method of a heat-not-burn device described above.

The present invention further constructs a heat-not-burn device, including a processor and a memory storing a computer program, where when executing the computer program, the processor implements the steps of the heating control method of a heat-not-burn device described above.

The present invention further constructs a heating structure, including a heating element and a tube element, where the heating element is powered on for heating according to the foregoing heating control method and is configured to radiate infrared light, the heating element is at least partially spaced from the tube wall of the tube element, the tube wall of the tube element allows the infrared light to penetrate through, and the infrared light is configured to heat an aerosol-forming substrate.

Preferably, the heating element includes a heating substrate and an infrared radiation layer disposed on the outer surface of the heating substrate, where the heating substrate is powered on for heating and is configured to excite the infrared radiation layer to radiate infrared light.

Preferably, the tube element is configured to be at least partially inserted into an aerosol-forming substrate and includes a body portion and a tip portion disposed at one end of the body portion, and the heating element is spaced from the inner wall of the body portion.

Preferably, the heating element is disposed in the periphery of the tube element, an accommodating cavity is disposed in the tube element, and the aerosol-forming substrate is at least partially accommodated in the accommodating cavity.

The following clearly and completely describes the technical solutions in the embodiments of the present invention with reference to the accompanying drawings in the embodiments of the present invention. Apparently, the described embodiments are some of the embodiments of the present invention rather than all of the embodiments. All other embodiments obtained by a person of ordinary skill in the art based on the embodiments of the present invention without creative efforts shall fall within the protection scope of the present invention.

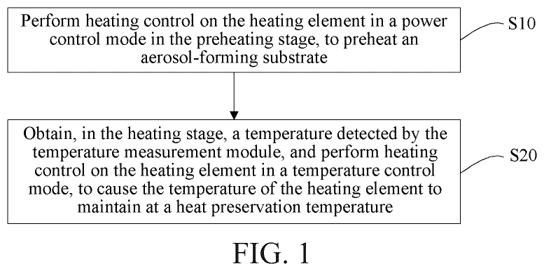

FIG. 1 is a flowchart of a heating control method for a heat-not-burn device according to Embodiment 1 of the present invention. The heating control method of this embodiment is applied to a processor of the heat-not-burn device. The heat-not-burn device further includes a heating element, a power supply, a temperature measurement module, and the like. The power supply supplies energy to the heating element. The temperature measurement module is configured to detect a temperature. Specifically, the temperature detected by the temperature measurement module may be a temperature of the heating element, or may be a temperature of an aerosol-forming substrate, or may be a temperature of a heating cavity. The heating element may have a plurality of forms, for example, may be a heating barrel, a heating slice, a heating pin, a heating bar, or a heating cable or wire. Alternatively, the heating element may be a combination of the heating components in the foregoing two or more different forms.

As shown in FIG. 1, the heating control method for a heat-not-burn device in this embodiment includes the following steps:

Step S10: Perform heating control on the heating element in a power control mode in the preheating stage, to preheat an aerosol-forming substrate.

In this step, heating may be started by long-pressing a button on the heat-not-burn device, or heating may be started automatically when it is detected that an aerosol-forming substrate is inserted. In addition, after heating is started, because a temperature currently detected by the temperature measurement module lags behind, the temperature inside the aerosol-forming substrate cannot be truly reflected. Besides, a temperature change at this stage is relatively large. In this way, the detected temperature lags behind, which leads to inaccurate temperature control. Therefore, high-power heating is performed on the heating element in the power control mode in the preheating stage, that is, a processor controls only the value of a heating power and the length of a heating duration, for example, the heating power is greater than 10 W, and the heating duration is 1 s to 10 s, and the heating element is not controlled according to the temperature detected by the temperature measurement module. In the preheating stage, the heating element rapidly warms up, and with the radiation of infrared light, a preheat temperature of the aerosol-forming substrate can reach 300° C. to 400° C. (including two endpoint values and any value between the endpoint values). Therefore, the aerosol-forming substrate can be heated so that aerosols can be generated within a short time, and even a smoking condition can be reached within Is to 3s. In the present invention, a high power is generally a power greater than or equal to 5 W. It should be noted that, in some embodiments, in the preheating stage, the preheat temperature of the aerosol-forming substrate reaches 300° C. to 400° C. However, a maximum operating temperature of a local region (at least a local area in contact with the aerosol-forming substrate) of the heating element in this stage reaches approximately 550° C. The temperature lasts for a relatively short time, and heat can be rapidly dissipated. Therefore, the aerosol-forming substrate is not burned.

Step S20: Obtain, in the heating stage, a temperature detected by the temperature measurement module, and perform heating control on the heating element in a temperature control mode, to cause the temperature of the heating element to maintain at a heat preservation temperature.

In this step, the heating stage may be entered after preheating, and a user can smoke at the heating stage. In addition, because temperature changes of the aerosol-forming substrate and the heating element are relatively small at this stage, the temperature currently detected by the temperature measurement module (which is the temperature of the heating element in this embodiment) can approximately truly reflect the heating temperature inside the aerosol-forming substrate. Therefore, heating control may be performed on the heating element in the temperature control mode based on the temperature detected by the temperature measurement module, to cause the temperature of the heating element to maintain at the heat preservation temperature. The heat preservation temperature is 180° C. to 380° C. (including two endpoint values and any value between the endpoint values). Specifically, when the user does not smoke, the heating element may be controlled to reduce the temperature by not adding a power or reducing the power. When the temperature is reduced to the heat preservation temperature, the heating element is maintained at the heat preservation temperature. If it is detected that the user smokes, the temperature of the heating element quickly decreases. If the temperature decreases excessively quickly and is below the heat preservation temperature, the heating element may be controlled to heat until the heat preservation temperature is reached again, to wait for subsequent smoking by the user. In some embodiments, at the heat preservation stage, the aerosol-forming substrate is in a state of continuously generating aerosols, and this process is equivalent to continuously pre-storing at least one puff of aerosols, reducing the temperature after smoking, and then heating the pre-stored aerosols. This process is repeated. The heat preservation temperature is preferably controlled to 200° C. to 330° C. (including two endpoint values and any value between the endpoint values).

According to the technical solution of this embodiment, heating control is performed on the heating element in the power control mode in the preheating stage; and a temperature detected by the temperature measurement module is obtained in the heating stage, and heating control is performed on the heating element in a temperature control mode. In this control manner differentiating different stages, because the power control mode is used in the preheating stage, even if the temperature initially detected by the temperature measurement module lags behind, the heating control of the heating element is not affected, and this helps to eliminate the difference between the working of different instruments. However, a temperature change of the heating element is relatively small at the heating stage, and the temperature detected by the temperature measurement module at this time approximately truly reflects the temperature inside the aerosol-forming substrate. Besides, a temperature feedback lag at this stage has relatively small impact on temperature control. Therefore, the heating element is controlled in the temperature control mode at this stage, to ensure consistency of taste of aerosols.

Further, in an optional embodiment, the heating control method of the present invention further includes:
if the first smoking action is detected in the preheating stage, or a current preheat time reaches a first preset time, entering the heating stage.

Further, the heating control method of the present invention further includes:
outputting a reminder signal if no first smoking action is detected in the preheating stage within a second preset time, where the second preset time is less than or equal to the first preset time.

In a specific embodiment, assuming that the first preset time is 6 s and the second preset time is 3 s, after starting heating, the user may be prompted to smoke after 3 s. If the user does not smoke, the heating element may be controlled to run at a low power after 6 s.

Further, in an optional embodiment, in step S10, the step of preheat the aerosol-forming substrate includes: preheating the aerosol-forming substrate through infrared radiation, and further includes a manner of heat conduction. In step S20, the step of maintaining the temperature of the heating element at a preset heat preservation temperature includes: maintaining the temperature of the heating element at the preset heat preservation temperature, and heating the aerosol-forming substrate through infrared radiation. In this embodiment, the aerosol-forming substrate is heated through infrared radiation, and a wavelength of infrared light mainly concentrates between 2 μm to 4.75 μm (including two endpoint values and any value between the endpoint values) and 8 μm to 11 μm (including two endpoint values and any value between the endpoint values). In addition, the heating element instantly (generally within 3 s) warms up to 500° C. or even above 1000° C., and the infrared light rapidly heats the aerosol-forming substrate. Therefore, a preheat time is very short, aerosols may be quickly generated, and the user can usually smoke after around 3 seconds. In addition, the infrared light has strong transparency and uniform heating, and energy is not excessively accumulated at a point or a surface. Therefore, aerosols can be rapidly generated without burning, thereby ensuring consistency of taste.

In a specific embodiment, the structure of the component used for heating includes a quartz tube and a heating element disposed inside the quartz tube. The heating element is at least partially spaced from the quartz tube. The heating element includes a metal substrate and an external infrared radiating layer. The entire heating element may be a single-spiral structure, a double-spiral structure, or an N-shaped structure formed by wrapping a heating wire, or may be in the shape of barrel, sheet, or column. The temperature measurement module may be disposed on the quartz tube. For example, a temperature measurement film is adhered to the wall of the quartz tube. In addition, a heating principle of the heating element is: the heating element heats the aerosol-forming substrate mainly through infrared radiation, combined with heat conduction by the heating element. Different from the heating element in the prior art, a maximum temperature of the heating element in this embodiment can reach 1300° C., is usually 500° C. to 1000° C., and is preferably 600° C. to 800° C. in a steady heating process (a maximum local temperature of the heating element in the prior art is approximately 420° C.). In this temperature interval, the infrared radiating layer mainly radiates a light wave having a wavelength of 2 μm to 14 μm, especially, a light wave having a wavelength of 2 μm to 4.75 μm. This is a wavelength range in which the aerosol-forming substrate is easily absorbed and rapidly heated.

In addition, in the prior art, a maximum local temperature of a heating portion of the heating element is within 420° C., and a temperature of a portion in contact with the aerosol-forming substrate is controlled at approximately 350° C. (for some heating elements, heating portions are directly in contact with the aerosol-forming substrate, or for other heating elements, there are external tube elements, the heating elements are in close contact with the tube elements, the tube elements are in contact with the aerosol-forming substrate, and heating is performed through heat conduction based on physical contact). However, the temperature of the heating element in this solution cannot be excessively high, and a temperature higher than 420° C. may make the aerosol-forming substrate generate aerosols faster, but the temperature of a portion in contact with the aerosol-forming substrate is also excessively high. Because of heat conduction based on physical contact, a heat capacity of the heat generating portion is relatively large, a temperature drop in a rear portion thereof is very slow, and a high temperature for a long time definitely burns the aerosol-forming substrate. Therefore, an existing product cannot balance fast aerosol generation and consistent taste, which cannot be effectively resolved for now. According to the heating element in the prior art, because a temperature of the heating element cannot be higher than 420° C., and heat conduction efficiency based on direct physical contact is relatively low, an initial preheat time needs to be relatively long, and generally preheating needs to be performed for more than 15 seconds for normal smoking. In addition, because the heat conduction efficiency is relatively low, a temperature at a heat preservation stage within a smoking interval cannot be excessively low. Otherwise, an amount of aerosols in a next puff is relatively small. Therefore, heat needs to be preserved at a relatively high temperature. The entire aerosol-forming substrate needs to be completely smoked within approximately 5 minutes, because the entire aerosol-forming substrate is basically completely charred within approximately 5 minutes.

In an embodiment of the present invention, the heating element is at least partially spaced from the quartz tube. Preferably, the heating element is entirely not in contact with the quartz tube, or only the top of the heating element is in contact with the top of the quartz tube. The temperature of the heating element may be as high as 1300° C., is generally controlled to 500° C. to 1000° C., and is preferably 600° C. to 800° C. in a steady heating process. The entire heating process may be divided into two main stages:

Preheating stage: A preheat time is very short, to achieve rapid aerosol generation, and usually a user can smoke within approximately 3 seconds. This is because the heating element can be rapidly heated to above 500° C., most of the energy is infrared light radiated by the heating substrate, and the wavelength is mainly concentrated in 2 μm to 14 μm, especially, 2 μm to 4.75 μm, and the radiation energy is absorbed by the aerosol-forming substrate to rapidly heat up. Some of the energy is heat-conducted to the quartz tube with air as a medium, and after the quartz tube heats up, the energy is then heat-conducted to the aerosol-forming substrate. Other energy is also radiated in a form of light waves, then is absorbed by the quartz tube to increase the temperature, and infrared light is radiated to the outside. Therefore, the aerosol-forming substrate quickly generates aerosols mainly because the e-liquid substrate absorbs light waves of the 2 μm to 14 μm wavelength to generate heat, which is much more efficient than direct heat conduction. At the same time, the heat conduction and radiation of the quartz tube also have impact to some extent.

Steady heating stage: A user is prompted to smoke after the preheating stage, for example, after 3 seconds. If the user does not smoke, a controller controls the heating element to run at a low power after approximately 6 seconds. In this case, because the heating element of this solution has a relatively small heat capacity, after the power is reduced, the temperature of the heating element may be quickly reduced. In this case, the energy of the light waves of the heating element that can be absorbed by the aerosol-forming substrate is also sharply reduced. In addition, the space between the heating element and the quartz tube greatly reduces heat conduction. Therefore, the temperatures of the aerosol-forming substrate and the quartz tube also quickly decrease. If the user currently smokes, cool air from the outside may carry away a large amount of heat, and the temperatures of the aerosol-forming substrate and the quartz tube may also rapidly decrease. Subsequently, a low temperature is preserved or heating is rapidly performed as the user smokes, to generate aerosols.

Further, in an optional embodiment, in step S10, the step of performing heating control on the heating element in a power control mode includes:
obtaining, when heating is started, an initial temperature detected by the temperature measurement module; and
determining an initial heating power of the heating element based on the initial temperature.

In this embodiment, the initial heating power may be determined according to a temperature (which may be a temperature of the heating element, a temperature of the heating cavity, or a temperature of the inner wall of the heating cavity) detected by the temperature measurement module. Specifically, in a cold state, the initial temperature is lower, and in this case, a greater initial heating power is required. In a non-cold state, for example, when the user continuously smokes after completing one cigarette, the initial temperature is higher, and in this case, a smaller initial heating power is required.

Further, in an optional embodiment, in step S10, the step of performing heating control on the heating element in a power control mode includes:
performing heating control on the heating element in a constant power control mode; or
performing heating control on the heating element in a variable power control mode.

In this embodiment, the constant power control mode may be used in the preheating stage, for example, heating is performed for 3 s with a 15 w power, or the variable power control mode may be used, for example, heating is performed for the 1st second with the 15 w power, heating is performed for the 2nd second with a 17 w power, and heating is performed for the 3rd second with a 14 w power. In addition, the variable power control mode is preferred because under variable power control, the light wave and the temperature are more suitable for uniform heating, and taste is more consistent. Finally, it should be noted that, both power control modes prioritize rapid aerosol generation.

Further, in an optional embodiment, the heating control method of the present invention further includes:
collecting statistics on a current total number of times of smoking and/or a current accumulated heating time, and adjusting the heat preservation temperature according to the current total number of times of smoking and/or the current accumulated heating time.

In this embodiment, the statistics on a total number of times of smoking or an accumulated heating time may be collected each time a smoking action is detected, and then the heat preservation temperature is dynamically adjusted based on the total number of times of smoking and/or the accumulated heating time. For example, as the total number of times of smoking increases or the accumulated heating time increases, the heat preservation time is gradually increased, to ensure consistency of taste. Certainly, in another embodiment, the heat preservation temperature may also be set to a fixed value.

Further, in an optional embodiment, the step of obtaining a temperature detected by the temperature measurement module, and performing heating control on the heating element in a temperature control mode includes:
obtaining, in real time, a temperature detected by the temperature measurement module, and using the temperature as a detected temperature value;
using the heat preservation temperature as a target temperature value; and
performing PID calculation on the detected temperature value and the target temperature value, and performing heating control on the heating element according to a PID calculation result.

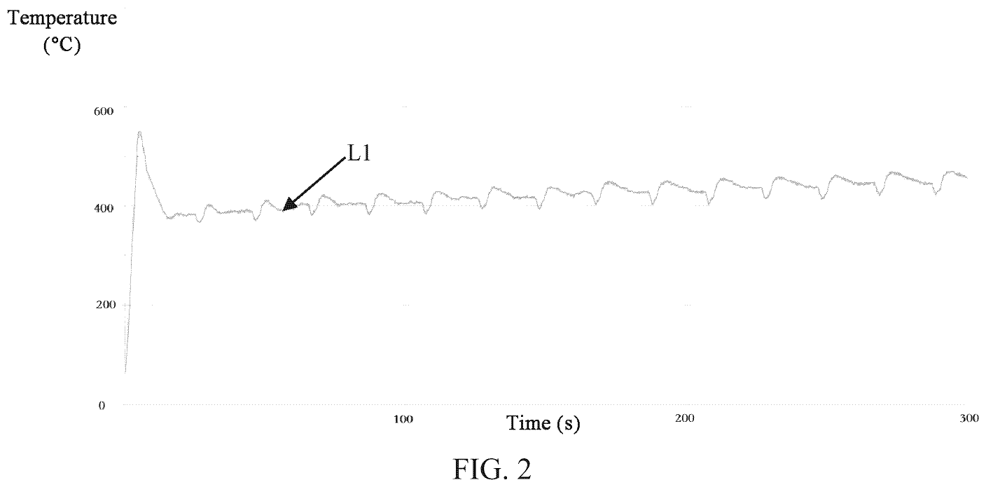

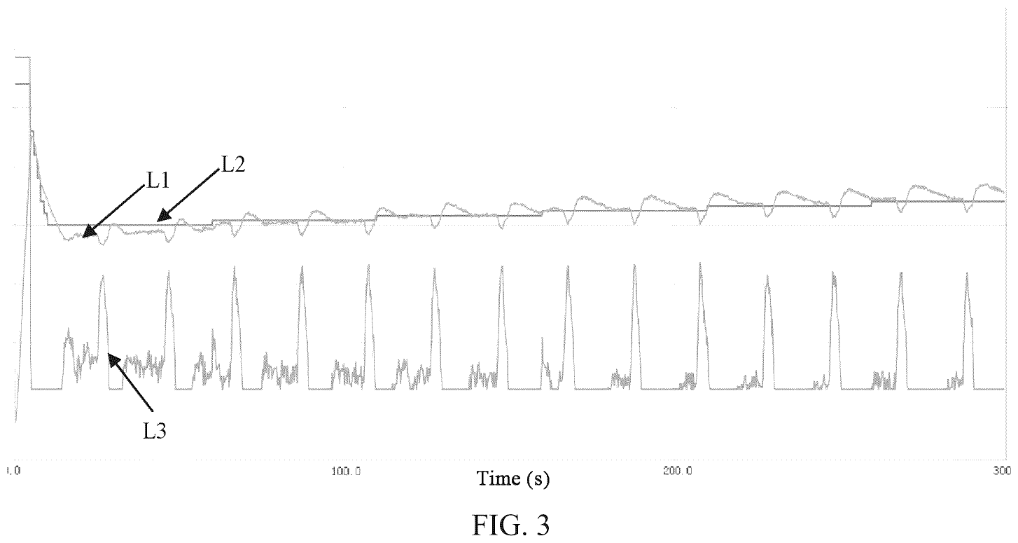

In this embodiment, with reference to FIG. 2 and FIG. 3, a curve L1 is a curve of temperatures actually detected by the temperature measurement module, a curve L2 is a curve of heat preservation temperatures, and a curve L3 is a curve of output powers. The actually detected temperature is used as a detected temperature value, the heat preservation temperature is used as a target temperature value, and heating control is performed on the heating element through a PID algorithm. Specifically, when the temperature detected by the temperature measurement module is greater than the heat preservation temperature, the heating is stopped or the output power is reduced. When the temperature detected by the temperature measurement module is less than the heat preservation temperature, the output power is increased, so that the temperature of the aerosol-forming substrate is always maintained near the heat preservation temperature. That is, the aerosol-forming substrate remains in a state of aerosol generation in the heating stage. When a user smokes, aerosols are discharged, and the temperature of the heating element is reduced. If the actually detected temperature is lower than the heat preservation temperature, the heating element is controlled to heat up according to a difference between the actually detected temperature and the heat preservation temperature, and the heat preservation temperature is maintained again. The aerosol-forming substrate continuously generates and stores aerosols, to wait for smoking by the user again.

Further, the heating control method of the present invention further includes:
stopping heating control on the heating element when determining that a preset stop condition is met, where the preset stop condition includes at least one of the following:
a total number of times of smoking reaches a preset number of times;
an accumulated heating time reaches a third preset time; and
a stop instruction inputted by a user is received.

In this embodiment, when the total number of times of smoking reaches a specified number of times (for example, 10 to 16 puffs), or an entire smoking time exceeds a specified time, or a user inputs a stop instruction (for example, long-presses a button on an e-cigarette), heating of the heating element may be stopped.

The present invention further constructs a computer storage medium, the computer storage medium storing a computer program, where the computer program, when executed by a processor, implements the steps of the heating control method of a heat-not-burn device described above.

The computer-readable storage medium of the present invention may be various computer-readable storage mediums capable of storing program code, such as a USB flash drive, a removable hard disk, a read-only memory (ROM), a magnetic disk, or an optical disc.

The present invention further constructs a heat-not-burn device, including a processor and a memory storing a computer program, where when executing the computer program, the processor implements the steps of the heating control method of a heat-not-burn device described above.

The processor of the present invention is configured to provide computing and control capabilities, to support operation of the entire heat-not-burn device. It should be understood that in the embodiments of the present application, the processor can be a central processing unit (CPU), or may be another general-purpose processor, a digital signal processor (DSP), an application-specific integrated circuit (ASIC), a field programmable gate array (FPGA) or another programmable logic device, a discrete gate or transistor logic device, or a discrete hardware component, or the like. The general-purpose processor may be a microprocessor, or the processor may be any conventional processor or the like.

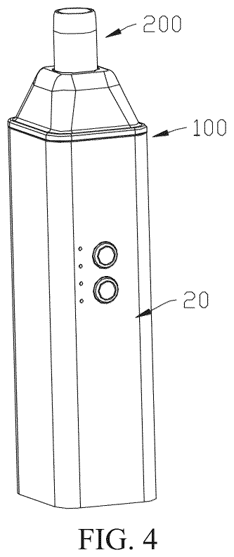

FIG. 4 is a structural diagram of a heat-not-burn device according to a first embodiment of the present invention. A heat-not-burn device 100 of this embodiment may heat an aerosol-forming substrate 200 at a low temperature in a heat-not-burn manner, and has good atomization stability and good atomization taste. In some applications, the aerosol-forming substrate 200 may be provided on the heat-not-burn device 100 in a pluggable manner. The aerosol-forming substrate 200 may be columnar. Specifically, the aerosol-forming substrate may be a solid material in the shape of a filament or sheet or an integral form made of leaves and/or stalks of a plant, and an aroma component may be further added to the solid material.

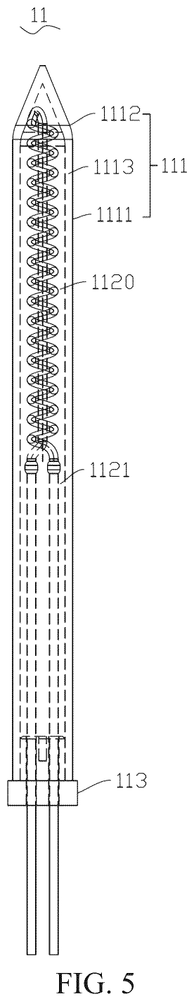

As shown in FIG. 4 and FIG. 5, further, in this embodiment, the heat-not-burn device 100 includes a heating structure 11 and a power supply component 20. The heating structure 11 may be partially inserted into the aerosol-forming substrate 200. Specifically, the heating structure may be partially inserted into a medium segment of the aerosol-forming substrate 200, and infrared light waves are generated in a powered-on state to heat the medium segment of the aerosol-forming substrate 200, so that the aerosol-forming substrate is atomized to generate aerosols. The heating structure 11 has the advantages of simple structure, high atomization efficiency, strong stability, and long service life. The power supply component 20 is configured to supply power to the heating structure 11.

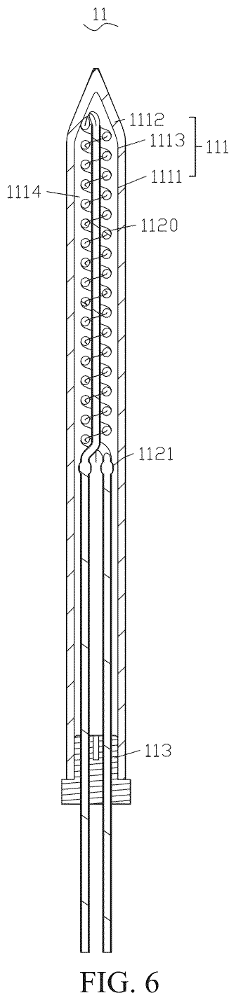

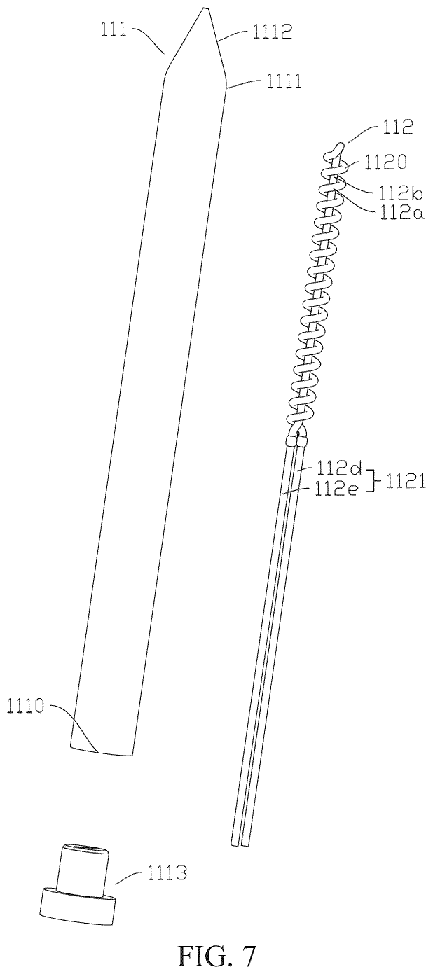

As shown in FIG. 5 to FIG. 7, in this embodiment, the heating structure 11 includes a tube element 111, a heating element 112, and a base 113. The tube element 111 is sleeved on at least a part of the heating element 112, and may allow light waves to penetrate into the aerosol-forming substrate 200. Specifically, in this embodiment, the tube element 111 may allow infrared light to penetrate through, so that the heating element 112 may radiate infrared light to heat the aerosol-forming substrate 200. The base 113 is disposed at an opening 1110 of the tube element 111, and is configured to fix the tube element 111.

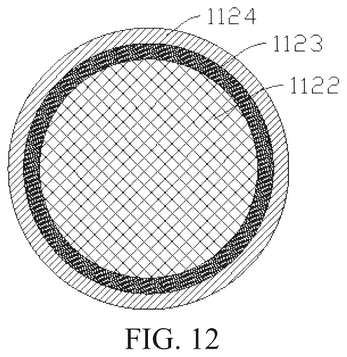

As shown in FIG. 12, in this embodiment, the heating element 112 includes a heating substrate 1122 and an infrared radiation layer 1124. The heating substrate 1122 is powered on for heating according to the foregoing heating control method. In a powered-on heating state, the heating substrate 1122 may excite the infrared radiation layer 1124 to generate and radiate infrared light. The infrared radiation layer 1124 is disposed on an outer surface of the heating substrate 1122.

In some embodiments, the heating element 112 includes a heating substrate 1122 and an infrared radiation layer 1124 covering the exterior of the heating substrate. The heating substrate 1122 includes a metal substrate with high-temperature anti-oxidation performance, such as a metal wire. The heating substrate 1122 may be a nickel-chromium alloy substrate (such as nickel-chromium alloy wire), an iron-chromium-aluminum alloy substrate (such as iron-chromium-aluminum alloy wire) or the like made of a metal material with good high-temperature anti-oxidation performance, high stability, and good deformation resistance. In some embodiments, the diameter of the metal wire may be 0.15 mm to 0.8 mm (including two endpoint values and any value between the endpoint values). In addition, the metal wire (the heating substrate) may be bent or wound to form a heating portion of various shapes. For example, as shown in FIG. 5 to FIG. 7, the metal wire may be bent to form a heating portion 1120 having a spiral cylindrical shape. It may be understood that in some other embodiments, the heating substrate may be wound to form a heating portion having a single-spiral shape, a double-spiral shape, an M shape, an N shape, or other shapes.

In some embodiments, the heating element further includes an anti-oxidation layer 1123, and the anti-oxidation layer 1123 is formed between the heating substrate 1122 and the infrared radiation layer 1124. Specifically, the anti-oxidation layer 1123 may be an oxide film. A layer of dense oxide film is generated on the surface of the heating substrate 1122 by performing high-temperature heat treatment. The oxide film forms the anti-oxidation layer 1123. Certainly, it may be understood that, in some other embodiments, the anti-oxidation layer 1123 includes an oxide film formed by the anti-oxidation layer, but this constitutes no limitation. In some other embodiments, the anti-oxidation layer may be an anti-oxidation coating applied to the outer surface of the heating substrate 1122. The thickness of the anti-oxidation layer 1123 may be selected as from 1 um to 150 um (including two endpoint values and any value between the endpoint values).

In some embodiments, the infrared radiation layer 1124 may be an infrared layer. The infrared layer may be formed on a side of the anti-oxidation layer away from the heating substrate by an infrared-layer-forming substrate through high-temperature heat treatment. Specifically, the infrared-layer-forming substrate may be silicon carbide, spinel, or a composite substrate thereof. Certainly, it may be understood that, in some other embodiments, the infrared radiation layer 1124 is not limited to the infrared layer. In some other embodiments, the infrared radiation layer may be a composite infrared layer. Specifically, the infrared layer may be formed on a side of the anti-oxidation layer away from the heating substrate through dip coating, spray coating, brush coating, and other methods. The thickness of the infrared radiation layer 1124 may be 10 um to 300 um (including two endpoint values and any value between the endpoint values).

In this embodiment, the tube wall of the tube element 111 is spaced from the entire heating element 112. For example, a gap 1114 is reserved between the tube element 111 and the heating element 112. The gap 1114 may be filled with air. Certainly, it may be understood that, in some other embodiments, the gap 1114 may also be filled with a reducing gas or an inert gas. By reserving the gap 1114, there is no direct contact between the tube element 111 and the heating element 112. In some embodiments, the heating element 112 may also be partially spaced from the tube wall of the tube element 111. Specifically, the radial dimension of a partial segment of the heating portion 1120 may be greater than the radial dimension of another partial segment, and the radial dimension of a partial segment of the heating portion 1120 may be equal to the inner diameter of the tube element 111, thereby achieving a position limiting function. Certainly, it may be understood that, in some embodiments, the inner side of the tube wall 111 may partially project towards the heating element 112 to be in contact with the heating element 112, thereby achieving a position limiting function. Certainly, it may be understood that, in some other embodiments, an isolating positioning structure may be provided on the heating element 112 or the tube wall of the tube element 111, so that the heating element 112 is not in direct contact with the tube wall of the tube element 111. For example, a ceramic ring is sleeved on a partial segment of the heating element 112. It needs to be noted that the gap may be a gap accessible to air, and does not mean that air or another gas necessarily exists. A vacuum state is also a form of the gap. To obtain better smoking taste and prolong the service life of the heating element, the tube element 111 may also be provided by using vacuum or by sealing an open end.

In this embodiment, the heating portion 1120 includes a first heating portion 112a and a second heating portion 112b, and one end of the first heating portion 112a is connected to one end of the second heating portion 112b. the first heating portion 112a and the second heating portion 112b are integrally formed structures, and may be formed by bending one heating element 112. It may be understood that, in some other embodiments, the first heating portion 112a and the second heating portion 112b may also be split structures, and the first heating portion 112a and the second heating portion 112b may be two heating elements 112 respectively. It may be understood that, in some other embodiments, the second heating portion 112b may also be omitted, or may be replaced by a non-heating conductive rod.

In addition, the heating element 112 further includes a conductive portion 1121 provided at one end of the heating portion 1120. The conductive portion 1121 is connected to the heating portion 1120, may be led out from one end of the tube element 111, and may penetrate out of the base 113 to be conductively connected to the power supply component 20. The conductive portion 1121 may be fixed to the heating portion 1120 through welding. Certainly, it may be understood that, in some other embodiments, the heating portion 1120 may be integrally formed with the conductive portion 1121, and the first free end 112d and the second free end 112e of the heating element 112 may separately form two conductive portions 1121. That is, the first free end 112d of the first heating portion 112a forms one of the conductive portions 1121; and the second free end 112e of the second heating portion 112b forms the other conductive portion 1121. In some other embodiments, the conductive portion 1121 may be a lead wire, which may be welded to the heating portion 1120. Certainly, it may be understood that, in some other embodiments, the conductive portion 1121 is not limited to a lead wire, and may be other conductive structures.

In this embodiment, the tube element 111 may be a quartz glass tube. Certainly, it may be understood that, in some other embodiments, the tube element 111 is not limited to a quartz tube, and may be another window material that may allow light waves to penetrate through, for example, transparent infrared glass, transparent ceramics, or diamond.

In this embodiment, the tube element 111 is in the shape of a hollow tube and has two ends distributed along the axial direction, and is configured to be at least partially inserted into the aerosol-forming substrate 200. Specifically, the tube element 111 includes a body portion 1111 and a tip portion 1112 disposed at one end of the body portion 1111, and the heating element 112 is spaced from the inner wall of the body portion 1111. Certainly, it may be understood that, in some other embodiments, the cross section of the tube element 111 is not limited to a circular shape. The body portion 1111 is a hollow structure provided with an opening 1110 at one end. The tip portion 1112 is provided at one end of the body portion 1111 away from the opening 1110. By providing the body portion 1111, the heating structure 11 is conveniently inserted into and removed from the aerosol-forming substrate 200. In this embodiment, a first accommodating cavity 1113 is formed on the inner side of the tube element 111, and the first accommodating cavity 1113 is a columnar cavity. In some other embodiments, the heating element 112 may be spaced on the periphery of the tube element 111, and a second accommodating cavity for accommodating the aerosol-forming substrate 200 may be formed on the inner side of the tube element 111.

In this embodiment, the tube wall of the tube element 111 is spaced from the entire heating element 112. For example, a gap 1114 is reserved between the tube element 111 and the heating element 112. The gap 1114 may be filled with air. Certainly, it may be understood that, in some other embodiments, the gap 1114 may also be filled with a reducing gas or an inert gas. By reserving the gap 1114, there is no direct contact between the tube element 111 and the heating element 112. In some embodiments, the heating element 112 may also be partially spaced from the tube wall of the tube element 111. Specifically, a conductive portion 1121 is provided at one end of the heating portion 1120. The conductive portion 1121 is connected to the heating portion 1120, may be led out from one end of the tube element 111, and may penetrate out of the base 113 to be conductively connected to the power supply component 20. The radial dimension of a partial section of the heating portion 1120 may be greater than the radial dimension of another partial section. The radial dimension of the partial section of the heating portion 1120 may be equal to the inner diameter of the tube element 111, thereby having a position limiting function.

In this embodiment, the top of the heating element 112 is at least partially in contact with the inner wall surface of the tip portion 1112. In this way, while the end of the heating element 112 close to the tip portion 1112 has a position limiting function for installation, it can be ensured that the middle of the heating element 112 is not in direct contact with the inner wall of the tube element 111. In addition, a heat dissipation area can be increased, and an excessively high temperature of the end of the heating element 1120 close to the tip portion 1112 can be avoided.

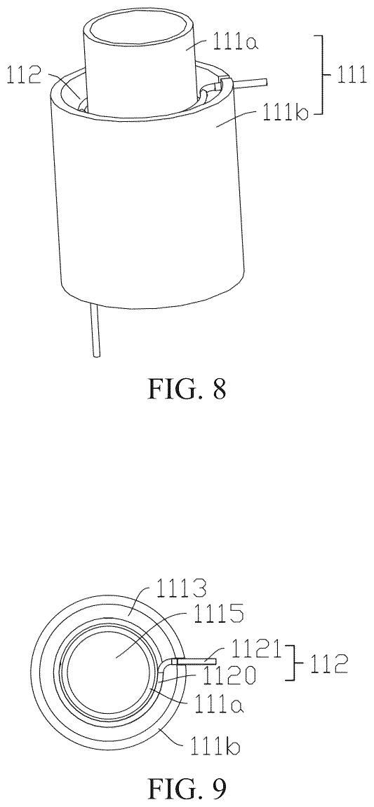

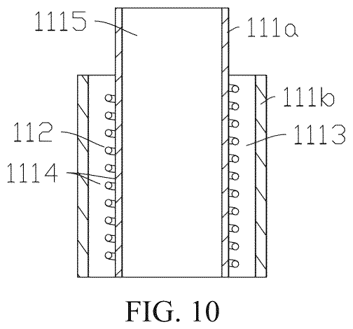

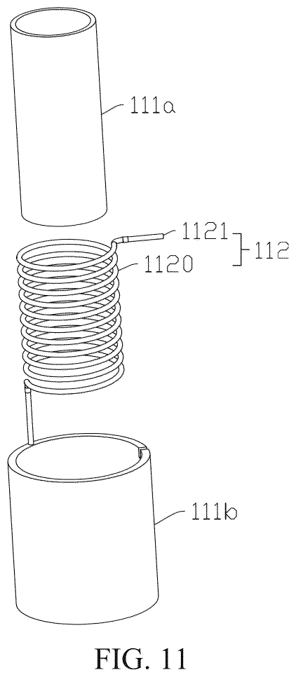

FIG. 8 to FIG. 11 show a heating structure in a heat-not-burn device according to another embodiment of the present invention. A difference from the foregoing embodiment lies in that the heating structure 11 is not limited to being partially inserted into the aerosol-forming substrate 200 to heat the aerosol-forming substrate 200. In this embodiment, the heating structure 11 may be sleeved on the periphery of a medium segment of the aerosol-forming substrate 200. Besides, the heating element 112 is disposed on the periphery of the tube element 111, and an accommodating cavity is provided inside the tube element 111. The aerosol-forming substrate is at least partially accommodated in the accommodating cavity. In this embodiment, the aerosol-forming substrate 200 is heated through circumferential heating.

In this embodiment, the tube element 111 includes a first tube element 111a and a second tube element 111b, and the first tube element 111a is a hollow structure with two ends in communication with each other. In addition, the first tube element 111a can be cylindrical and has an inner diameter that may be slightly larger than the outer diameter of the aerosol-forming substrate 200. A second accommodating cavity 1115 may be formed on the inner side of the first tube element 111a and configured to accommodate the aerosol-forming substrate 200 and form a heating space allowing the medium segment of the aerosol-forming substrate 200 to be heated. The axial length of the first tube element 111a may be greater than the axial length of the second tube element 111b. The second tube element 111b may be sleeved on the periphery of the first tube element 111a. The second tube element 111b may be cylindrical. The radial dimension of the second tube element 111b may be greater than the radial dimension of the first tube element 111a. That is, an interval is reserved between the second tube element 111b and the first tube element 111a. The interval may form a first accommodating cavity 1113. The first accommodating cavity 1113 is configured to accommodate the heating element 112. In some embodiments, the heating element 112 is wound around the periphery of the first tube element 111a, and a gap 1114 is reserved between the whole heating element and the inner wall of the second tube element 111b as well as the outer wall of the first tube element 111a, so that a temperature difference may be formed between the inner wall of the first accommodating cavity 1113 and the heating element 112, thereby achieving a heat insulation function. In some embodiments, a reflective layer may be provided on the inner wall of the second tube element 111b, and configured to reflect heat of the heating element 112 and radiate the heat to the aerosol-forming substrate 200, thereby enhancing the energy efficiency of heating.

In some other embodiments, the heating element 112 is completely spaced from the first tube element 111a or the second tube element 111b, but this constitutes not limitation. In some other embodiments, the heating element 112 may be partially spaced from the first tube element 111a, and the radial dimension of a partial segment of the heating portion 1120 may be equivalent to the outer diameter of the first tube element 111a, achieving a position limiting function. In some embodiments, the heating element 112 may also be partially spaced from the second tube element 111b, and the radial dimension of a partial segment of the heating portion 1120 may be equivalent to the radial dimension of the second tube element 111b.

In some embodiments, the heating element may alternatively be a plasma heating structure. Specifically, both the plasma heating structure and a laser heating structure are central heating structures. That is, the heating element is at least partially inserted into the aerosol-forming substrate. The plasma structure generally includes a glass tube element and two electrodes located in the glass tube element. The two electrodes are spaced from each other. After the two electrodes are powered on, a high voltage is generated between the electrodes and a gas medium is ionized, to form a high-voltage arc to generate heat. Therefore, the foregoing method is also applicable to a device of the plasma structure, or another heating structure that heats by using optical waves and in which an operating temperature of a heating element may be higher than 500° C.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating control method for a heat-not-burn device that includes a heating element and a temperature measurement module, the heating control method comprising:
performing heating control on the heating element in a power control mode in a preheat stage so as to preheat an aerosol-forming substrate; and
obtaining, in a heating stage subsequent to the preheating stage, a temperature detected by the temperature measurement module, and performing heating control on the heating element in a temperature control mode so as to cause a temperature of the heating element to maintain at a preset heat preserving temperature.

2. The heating control method of claim 1, wherein preheating the aerosol-forming substrate comprises preheating the aerosol-forming substrate through infrared radiation, and
wherein performing heating control on the heating element in the temperature control mode so as to cause the temperature of the heating element to maintain at the preset heat preserving temperature comprises: maintaining the temperature of the heating element at the preset heat preservation temperature, and heating the aerosol-forming substrate through infrared radiation.

3. The heating control method of claim 1, further comprising:
if a first smoking action is detected in the preheating stage, or a current preheat time reaches a first preset time, entering the heating stage.

4. The heating control method of claim 3, further comprising:
outputting a reminder signal if no first smoking action is detected in the preheating stage within a second preset time,
wherein the second preset time is less than or equal to the first preset time.

5. The heating control method of claim 3, wherein a preheat temperature in the preheating stage is 300° C. to 400° C., and/or the heat preservation temperature in the heating stage is 180° C. to 380° C., and/or the first preset time is 1 s to 10 s.

6. The heating control method of claim 1, wherein performing heating control on the heating element in a power control mode comprises:
obtaining, when heating is started, an initial temperature detected by the temperature measurement module; and
determining an initial heating power of the heating element based on the initial temperature.

7. The heating control method of claim 1, wherein performing heating control on the heating element in a power control mode comprises:
performing heating control on the heating element in a constant power control mode, or performing heating control on the heating element in a variable power control mode.

8. The heating control method of claim 1, further comprising:
collecting statistics on a current total number of times of smoking and/or a current accumulated heating time in the heating stage, and adjusting the heat preservation temperature according to the current total number of times of smoking and/or the current accumulated heating time.

9. The heating control method of claim 1, wherein obtaining the temperature detected by the temperature measurement module, and performing heating control on the heating element in the temperature control mode comprises:
obtaining, in real time, a temperature detected by the temperature measurement module, and using the temperature as a detected temperature value;
using the heat preservation temperature as a target temperature value; and
performing PID calculation on the detected temperature value and the target temperature value, and performing heating control on the heating element according to a PID calculation result.

10. The heating control method of claim 1, further comprising:
stopping heating control on the heating element when determining that a preset stop condition is met, the preset stop condition comprising at least one of:
a total number of times of smoking reaches a preset number of times,
an accumulated heating time reaches a third preset time, and a stop instruction inputted by a user is received.

11. A heat-not-burn device, comprising:
a processor; and
a memory storing a computer program,
wherein, when executing the computer program, the processor implements the heating control method of claim 1.

12. A heating structure, comprising:
a heating element; and
a tube element,
wherein the heating element is powered on for heating according to the heating control method of claim 1 and is configured to radiate infrared light,
wherein the heating element is at least partially spaced from a tube wall of the tube element,
wherein the tube wall of the tube element allows the infrared light to penetrate through, and
wherein the infrared light is configured to heat the aerosol-forming substrate.

13. The heating structure of claim 12, wherein the heating element comprises a heating substrate and an infrared radiation layer disposed on the outer surface of the heating substrate, and
wherein the heating substrate is powered on for heating and is configured to excite the infrared radiation layer to radiate infrared light.

14. The heating structure of claim 13, wherein the heating substrate comprises a nickel-chromium alloy substrate or an iron-chromium-aluminum alloy substrate.

15. The heating structure of claim 13, wherein the heating substrate comprises a metal wire windable so as to form a heating portion having a single-spiral shape, a double-spiral shape, an M shape, an N shape, or other shapes.

16. The heating structure of claim 13, wherein the heating element comprises an anti-oxidation layer formed between the heating substrate and the infrared radiation layer.

17. The heating structure of claim 13, wherein a thickness of the infrared radiation layer is 10 μm to 300 μm.

18. The heating structure of claim 12, wherein the tube element is at least partially insertable into the aerosol-forming substrate and comprises a body portion and a tip portion disposed at one end of the body portion, and
wherein the heating element is spaced from an inner wall of the body portion.

19. The heating structure of claim 18, wherein the tube element comprises a quartz glass tube, a transparent infrared glass tube, a transparent ceramics tube, or a diamond tube.

20. The heating structure of claim 12, wherein the heating element is disposed in a periphery of the tube element,
wherein an accommodating cavity is disposed in the tube element, and
the aerosol-forming substrate is at least partially accommodated in the accommodating cavity.
